(19) United States
(12) Patent Application Publication
(10) Pub. No.: US 2003/0125063 A1
(43) Pub. Date: Jul. 3, 2003

(54) Peer-to-peer communications within a mobile network

(76) Inventors: Bo Svensson, Locust Valley, NY (US); Peter L. Squillante, Northport, NY (US); John P. Evans, Levittown, NY (US); David Oren, Melville, NY (US); Karl P. Schwarz, Valley Stream, NY (US)

Correspondence Address: GARDERE WYNNE SEWELL LLP, 3000 Thanksgiving Tower, 1601 Elm Street, Suite 3000, Dallas, TX, 75201-4767, US

(21) Appl. No.: 10/141,736

(22) Filed: May 9, 2002

Related U.S. Application Data
(60) Provisional application No. 60/345,959, filed on Dec. 31, 2001.

(51) Int. Cl. H04Q 7/20

(52) U.S. Cl. 455/517; 455/502

(57) ABSTRACT

The present invention provides a method and apparatus for conducting peer-to-peer communications with a terminal via a wireless network (128). The present invention receives a request from the terminal (130) via the wireless network, updates one or more records of a mobile agent repository (404) based on the request such that the mobile agent repository (404) mirrors a content within a shared space on the terminal (130), and sends a response to the terminal (130) via the wireless network (128). The functionality described above can be implemented as a computer program embodied on a computer readable medium wherein each function is implemented as a code segment adapted to perform such function.

### RELATED APPLICATIONS

This patent application claims priority to U.S. provisional patent application 60/345,959 filed on Dec. 31, 2001.

### BACKGROUND OF THE INVENTION

A new sense of excitement runs through the Internet these days. It is driven primarily by the convergence of fixed communications technologies with the exponential growth in the mobile communications. For example, the capabilities of the Global System for Mobile Communications (“GSM”) second generation system (“2G”) and third generation (“3G”) mobile systems are being discussed and gradually implemented by operators to create the Mobile Internet. In addition to the Mobile Internet, Napster, Gnutella, Freenet and organizations like these have re-introduced a style of computing peer-to-peer communications that has captured the imagination of consumers, developers, businesspeople, entrepreneurs, copyright holders, and technology companies. Peer-to-peer capabilities include a new twist on Internet searching, file swapping, micro-payments, personal communication and other applications. But a cost efficient and effective mobile peer-to-peer communications system has not been developed.

For the most part, existing peer-to-peer computing innovations fall into three categories: direct access to information; direct access to computing power; and direct access to people. Direct access to information includes peer-to-peer search and file transfer tools, such as Napster and Gnutella. These methods have burst onto the Internet, disrupting not only the business models of copyright holders, but reorienting users' notions of what content is available and desirable. Direct access to computing power relates to a class of computations involving such massive amounts of data that they require supercomputers to perform them. Examples of these include pattern detection algorithms to help discover trends for weather forecasting, credit card fraud detection, stock market tracking, economic analysis, and corporate data mining. Peer-to-peer computing can greatly economize these computations by distributing the number crunching to peer computers found across a network. SETI@Home, which distributes the computations that listen for clues to the existence of extraterrestrial intelligence, is the most popular example of such a peer computing application deployed over the Internet. Direct access to people involves one of the most popular uses of the Internet in general. It is readily apparent that email far outdistances Web browsing and electronic commerce. In survey after survey, email remains the primary driver of Internet use and adoption. Similarly, instant messaging has gained increased popularity.

These hard wired peer-to-peer communication systems have not successfully migrated to the wireless domain because current mobile systems lack personal control, context, security, flexibility and cost effectiveness. There is, therefore, a need for a mobile peer-to-peer communications system that satisfies these requirements.

### SUMMARY OF THE INVENTION

The present invention provides a peer-to-peer mobile communications system that provides personal control, context, security, flexibility and cost effectiveness. The present invention provides a new level of flexibility and ad hoc sharing of information that when combined with mobility provides a whole new way of working, conducting business and interacting with family, associates and friends. These capabilities work equally well in the business environment as they do with consumers, and make transparent the use of fixed and mobile technologies by all parties using these applications.

More specifically, the present invention provides a method for conducting peer-to-peer communications with a terminal via a wireless network. The present invention receives a request from the terminal via the wireless network, updates one or more records of a mobile agent repository based on the request such that the mobile agent repository mirrors a content within a shared space on the terminal, and sends a response to the terminal via the wireless network. The functionality described above can be implemented as a computer program embodied on a computer readable medium wherein each function is implemented as a code segment adapted to perform such function.

In addition, the present invention provides an apparatus for conducting peer-to-peer communications with a terminal via a wireless network. The present invention includes a communications interface for communicably coupling to the terminal via the network, a navigator communicably coupled to the communications interface, and a repository communicably coupled to the navigator. The repository contains one or more records. The navigator receives a request from the terminal via the wireless network and the communications interface, updates one or more records of the repository based on the request such that the repository mirrors a content within a shared space on the terminal, and sends a response to the terminal via the wireless network and the communications interface.

Other features and advantages of the present invention will be apparent to those of ordinary skill in the art upon reference to the following detailed description taken in conjunction with the accompanying drawings.

### BRIEF DESCRIPTION OF THE DRAWINGS

For a better understanding of the invention, and to show by way of example how the same may be carried into effect, reference is now made to the detailed description of the invention along with the accompanying figures in which corresponding numerals in the different figures refer to corresponding parts and in which:

FIG. 1 is a block diagram of a peer-to-peer communications system for a mobile network in accordance with one embodiment of the present invention;

FIG. 2 is a block diagram of a peer-to-peer communications system for a mobile network in accordance with one embodiment of the present invention;

FIG. 3 is a block diagram of a connection tool in accordance with one embodiment of the present invention;

FIG. 4 is a block diagram of a mobile agent in accordance with one embodiment of the present invention;

FIG. 5 is a block diagram of a mobile client in accordance with one embodiment of the present invention;

FIG. 6 is a flowchart showing a method for peer-to-peer communications in a mobile network in accordance with one embodiment of the present invention; and

FIGS. 7A, 7B and 7C show various screen shots of a mobile client in accordance with one embodiment of the present invention.

### DETAILED DESCRIPTION OF THE INVENTION

While the making and using of various embodiments of the present invention are discussed in detail below, it should be appreciated that the present invention provides many applicable inventive concepts, which can be embodied in a wide variety of specific contexts. For example, in addition to telecommunications systems, the present invention may be applicable to other forms of communications or general data processing. Other forms of communications may include communications between networks, communications via satellite, or any form of communications not yet known to man as of the date of the present invention. The specific embodiments discussed herein are merely illustrative of specific ways to make and use the invention and do not limit the scope of the invention.

The present invention provides a peer-to-peer mobile communications system that provides personal control, context, security, flexibility and cost effectiveness. The present invention provides a new level of flexibility and ad hoc sharing of information that when combined with mobility provides a whole new way of working, conducting business and interacting with family, associates and friends. These capabilities work equally well in the business environment as they do with consumers, and make transparent the use of fixed and mobile technologies by all parties using these applications.

Personal Control. There is an immediacy to peer computing that is absent from Web computing. As mentioned earlier, peer computing provides direct access to content. A person not only can view the content, but also move the content from one peer device directly to his own. There is no greater degree of control over content than when the user has it stored locally, on his or her own machine. The user now “owns” that content; it is always available, whether or not the user is connected to the mobile or fixed network. Anyone who has saved the contents of email in a local directory, or detached a file, has participated in and appreciated the difference between ‘having’ the content and “viewing” the content on a Web site.

Context. This immediacy is even more apparent in direct communications, where the peers are not just devices but people. Personal peer interaction takes place in real time. That is, peers are able to go beyond merely sharing or swapping content, to talking with each other about that content, to jointly interacting with or modifying that content. In this way, an intuitive and shared context emerges from the marriage of content and activity.

Security. The Web is often an appropriate medium for sharing information among a group. On the other hand, some content is sensitive enough that users may not be comfortable using a Web server outside the home or corporate firewall to share it with others. Malicious or accidental access or deletion of Web-based content is not an altogether uncommon occurrence. Because peer computing does not rely on a third-party trusted intermediary, it lends itself nicely to highly secure communications and content sharing.

Flexibility. When a user owns the content and the collaboration environment, he or she can control how it is used. If the user wishes to do something with the data that the collaboration application doesn't readily support, he can add or use a different tool. For example, if a user does not like to use the built-in player that comes with a music swapping application, he can use an alternative music player. Because the content belongs to the end user, and not to the Web hosting service, the end user has broad discretion about how to view, manipulate and use that content.

Cost Effectiveness. Peer computing can have a significant positive impact on the system and human resources required for group interaction. For example, if a team of coworkers and contractors needs to meet regularly, investigate options, make decisions, and share documents, updates and ideas, they could use a shared space on a Web site without much expense. If, however, the Web site needed to accommodate hundreds of such teams, any number of which may be actively online at any given time, the Web site would need to expand in capacity. Because of the resources consumed, administrators have to police who can and who cannot create spaces; they have to do backups of these spaces; and, since most of the time no single member of a team assumes the responsibility of declaring the collaboration to be ‘over,’ administrators have to prod people to delete their shared spaces.

In an edge-based peer-to-peer environment, each member of a team makes use of his or her own local computing resources, without any worst-case capacity planning necessary. There is no need to have bandwidth, processing and storage enough to support the entire universe of users, only enough to support his or her own usage. And, when an individual user finds that stored assets no longer merit storage on a local machine, he or she can delete them without having to ask permission of the rest of the team. This eliminates the administrative burden of managing access to services, backing up resources that may be obsolete, and tracking down abusers of the system.

In an even simpler example, sending a single email with a file attachment to ten recipients, only to have some recipients reply to all with the file still attached, is very inefficient. Not only does this unnecessarily tax the network, but most client/server messaging systems will store a replica of the message and its attachments on both the client and the server. Peer-to-peer file transfer can minimize network traffic while eliminating redundant storage.

Speed. Some of the advantages of peer computing mentioned above, such as lo creating a shared context among a group, having the flexibility to add function on an as needed basis, and making connections without having to go through a centralized resource, naturally combine to speed purposeful action. In a peer computing environment, users can more easily gather people and content together to make more informed decisions more quickly.

In addition, peer-to-peer offerings possesses the same subscription based and prepaid characteristics of the operators current business model. The users provide both content and administration. As a result, network traffic is increased and no additional data storage or management requirements need be born by the operator.

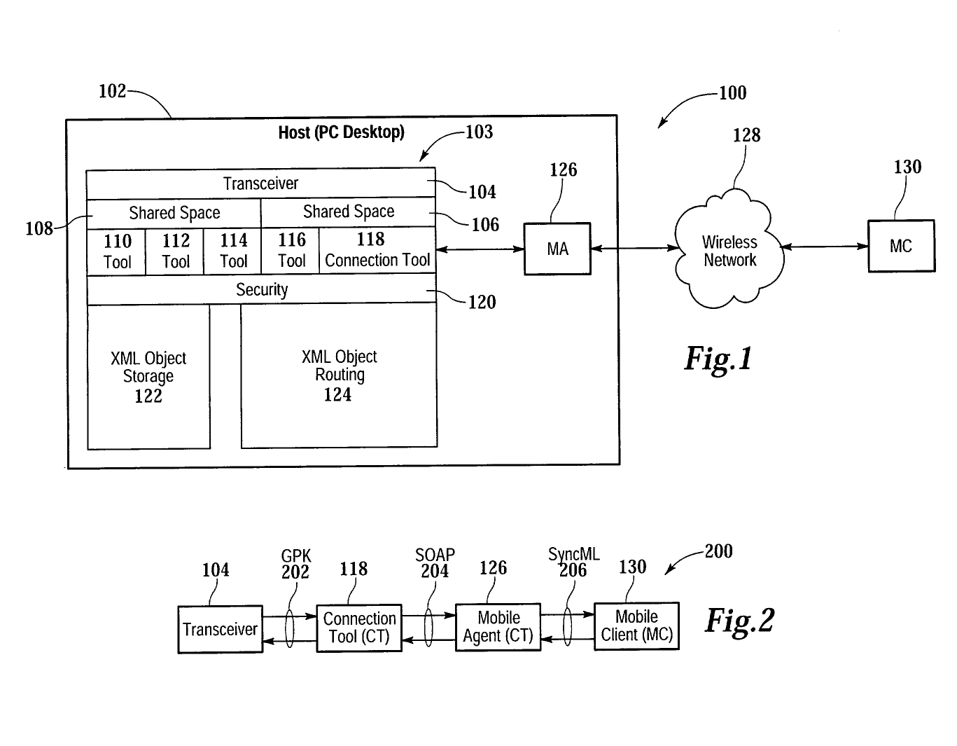

Referring to FIG. 1, a block diagram of a peer-to-peer communications system 100 for a mobile network 128 in accordance with one embodiment of the present invention is shown. The host computer 102, such as a personal computer desktop, hosts a peer-to-peer application 103 and a mobile agent 126. The peer-to-peer application 103 is available from various vendors, such as Groove Networks, JXTA by Sun Microsystems and .NET from Microsoft. With the exception of connection tool 118, FIG. 1 illustrates a peer-to-peer application 103 available from Groove Networks. The peer-to-peer application 103 includes a transceiver 104, one or more shared spaces 106 and 108, one or more tools 110, 112, 114 and 116, connection tool 118, security 102, XML Object Storage 122 and XML Object Routing 124. The transceiver 104 is communicably coupled to the connection tool 118 via a GDK protocol.

The transceiver 104 is the portion of the peer-to-peer application 103 that is visible to the user. All shared spaces 106 and 108 are fully private, such that only those members specifically invited by other members can see or create content. All content and activities are stored locally on the user's device in the XML Object Storage 122. At the same time that the peer-to-peer application 103 stores content and activities locally, it also passes all changes to the XML Object Routing 124, which passes the encrypted content to the appropriate end points on the peer network.

The connection tool 118 is communicably coupled to the mobile agent 126 via SOAP. The mobile agent 126 is communicably coupled to a mobile client 130 via wireless network 128 using a synchronizing protocol. The wireless network 128 can be a mobile network, the Internet, an Intranet, PSTN, etc. The mobile client 130 can be any type of terminal or handset, such as a Personal Data Assistant (“PDA”). The mobile client 130 can run on any PDA operating system, such as EPOC, PalmOS and PocketPC. The wired connectivity can be accomplished via LAN or Dial-up. The wireless connectivity can be accomplished via WiFi, Bluetooth, CDPD, GPRS, W-CDMA, CDMA2000 or any other applicable wireless infrastructure and Dial-up.

Now referring to FIG. 2, a block diagram of a peer-to-peer communications system 200 for a mobile network in accordance with one embodiment of the present invention is shown. The transceiver 104 is communicably coupled to the connection tool (“CT”) 118 and uses a GDK protocol 202. The connection tool 118 is communicably coupled to the mobile agent (“MA”) 126 using SOAP 204. The connection tool 118 can be implemented using any software language, such as JavaScript, peer-to-peer application tools, or BOT instances. The mobile agent 126 is communicably coupled to the mobile client (“MC”) 130 using a synchronization protocol 206, such as SyncML. The mobile agent 126 can be implemented using any software language on any platform, such as C/C++ on Windows 2000 or Linux. The mobile agent 126 acts as a server for both the connection tool 118 and the mobile client 130, and is the repository for the mobile client 130. The peer-to-peer application space information is replicated in the mobile agent 126. The mobile client 130 can be implemented using any software language on any platform, such as PocketPC using Java or PalmOS using C/C++. The mobile client 130 only provides space and tool functionality, which are hard coded and may provide limited administration functions.

When using a Groove Networks application, the connector tool 118 can be a BOT, in which case, the functionality of the mobile agent 126 would be migrated into this BOT. Two types of BOTs could be used: a personal BOT and an Enterprise BOT. The Personal BOT would be installed on the desktop running the regular peer-to-peer application 103. As a result, the PBOT does not need to have all the ability things taken care of. The target audience for this would be enthusiasts and professionals with desktops/laptops already running a peer-to-peer application 103. The Enterprise BOT, on the other hand, would act as space server for thousands, perhaps millions, of users. So here all the ability things becomes crucial. The target users here are professionals and consumers with mobile a device and no desktop/laptop running a peer-to-peer application 103. Both the PBOT and the EBOT would then allow mobile peer-to-peer users to keep their spaces in sync through regular SyncML sessions. The above-described functionality can be implemented on other applications from other vendors, although the terminology may be different.

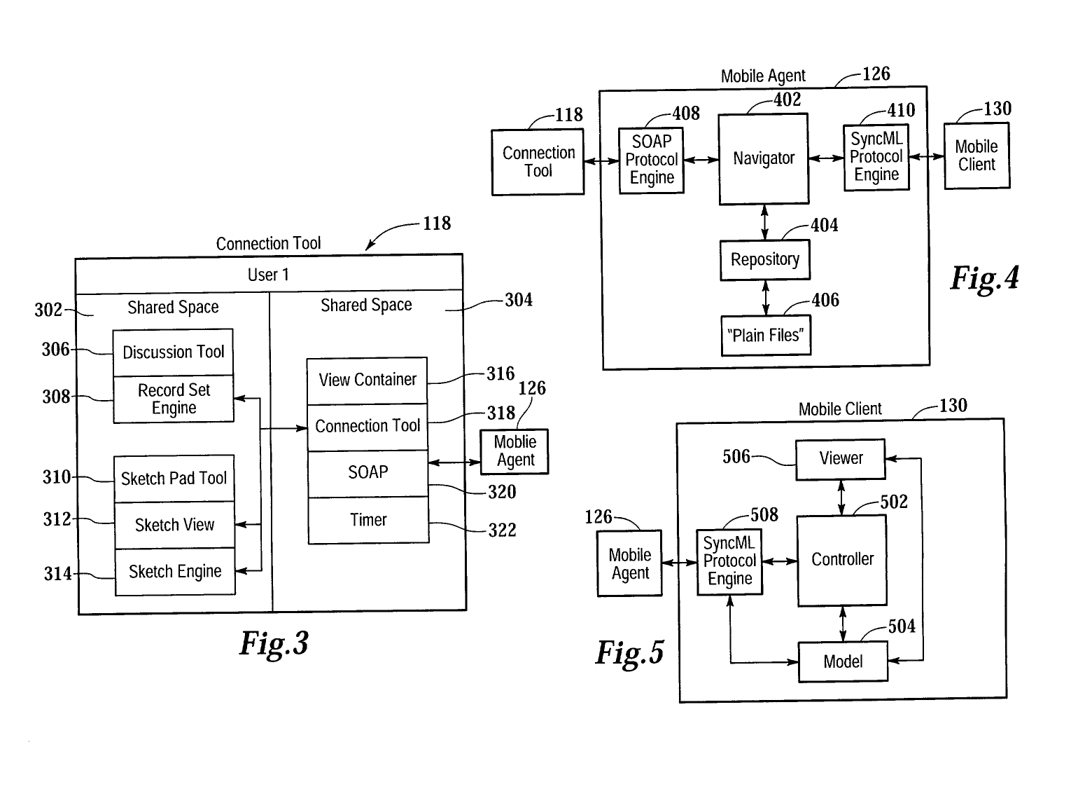

Referring now to FIG. 3, a block diagram of a connection tool 118 in accordance with one embodiment of the present invention is shown. The connection tool 118 includes a shared space 302 and a private space 304. The shared space 302 includes a discussion tool 306, a record set engine 308, a sketch pad tool 310, a sketch view 312 and a sketch engine 314. The record set engine 308 provides the following functions: OnFieldChanged, OnRecordSetChanged, AddRecord, RemoveRecord, Record.GetField, and Record.SetField. The private space 304 includes a view container 316, a connection tool 318, SOAP 320 and a timer 322. The view container 316 provides configuration and monitoring functions. The record set engine 308, sketch view 312, sketch engine 314 and connection tool 318 all communicate with one another. SOAP 320 is communicably coupled to the mobile agent 126. The SOAP 320 updates to the mobile agent 126 on demand and from the mobile agent 126 via polling. The timer 322 polls the mobile agent 126 periodically for changes.

Now referring to FIG. 4, a block diagram of a mobile agent 126 in accordance with one embodiment of the present invention is shown. The mobile agent 126 includes a navigator 402 communicably coupled to a repository 404 via an application programming interface, which contains data records or “plain files” 406. The navigator 402 is communicably coupled to a SOAP protocol engine 408 via an application programming interface, which is in turn communicably coupled to the connection tool 118. The navigator 402 is also communicably coupled to a synchronization protocol engine 410, such as SyncML, via an application programming interface, which is communicably coupled to mobile client 130.

Referring now to FIG. 5, a block diagram of a mobile client 130 in accordance with one embodiment of the present invention is shown. The mobile client 130 includes a controller 502, a model or data repository 504, a viewer 506 and a synchronization protocol engine 508, such as SyncML. The controller 502 is communicably coupled to the model 504, the viewer 506 and the synchronization protocol engine 508. In addition, the model 504 is communicably coupled to the viewer 506 and the synchronization protocol engine 508. The synchronization protocol engine 508 is communicably coupled to the mobile agent 126.

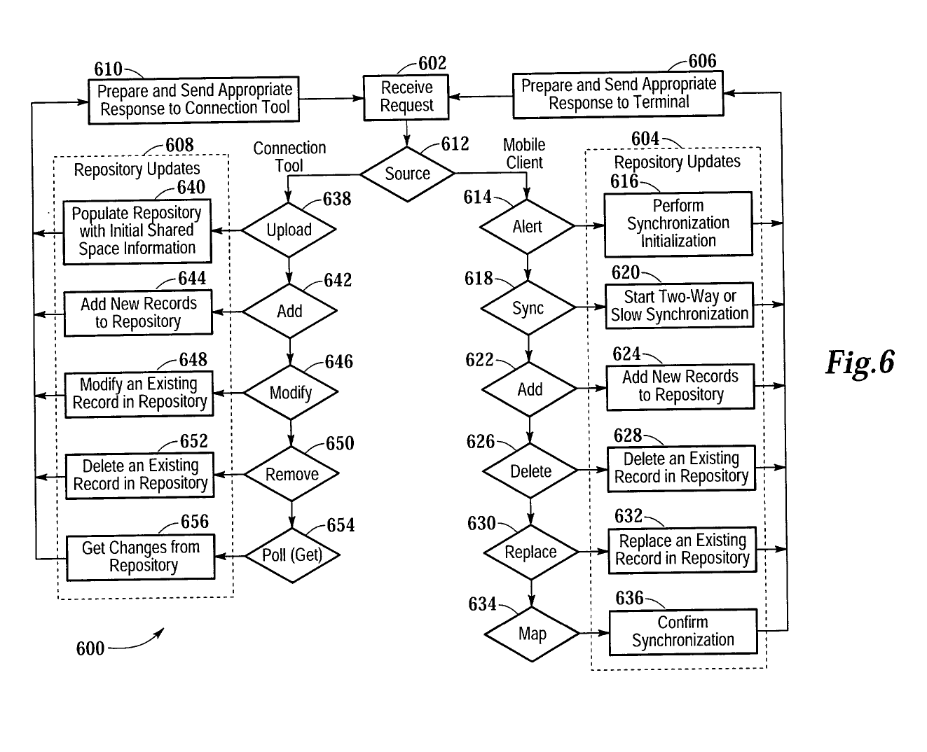

Now referring to FIG. 6, a flowchart showing a method 600 for peer-to-peer communications in a mobile network in accordance with one embodiment of the present invention is shown. This process 600 is viewed from the mobile agent 126. The mobile agent 126 receives a request in block 602. If the request is from the mobile client 130, as determined in decision block 612, the process updates 604 one or more records of a mobile agent repository based on the request such that the mobile agent repository mirrors a content within a shared space on the terminal, and prepares and sends the appropriate response to the mobile client 130. If, however, the request is from the connection tool 118, as determined in decision block 612, the process updates 608 the one or more records of a mobile agent repository based on the request from the connection tool, and prepares and sends the appropriate response to the connection tool 118 in block 610.

In one embodiment of the present invention, if the source of the request is the mobile client 130, as determined in decision block 612, and the request is an alert, as determined in decision block 614, the process performs a synchronization initialization in block 616, prepares and sends an appropriate response to the mobile client 130 in block 606, and waits for the next request in block 602. If, however, the request is not an alert, as determined in decision block 614, and the request is a sync, as determined in decision block 618, the process starts a two-way or slow synchronization in block 620, prepares and sends an appropriate response to the mobile client 130 in block 606, and waits for the next request in block 602. If, however, the request is not a sync, as determined in decision block 618, and the request is an add, as determined in decision block 622, the process adds new records to the repository in block 624, prepares and sends an appropriate response to the mobile client 130 in block 606, and waits for the next request in block 602. If, however, the request is not an add, as determined in decision block 622, and the request is a delete, as determined in decision block 626, the process deletes and existing record from the repository in block 628, prepares and sends an appropriate response to the mobile client 130 in block 606, and waits for the next request in block 602. If, however, the request is not a delete, as determined in decision block 626, and the request is a replace, as determined in decision block 630, the process replaces an existing record in the repository in block 632, prepares and sends an appropriate response to the mobile client 130 in block 606, and waits for the next request in block 602. If, however, the request is not a replace, as determined in decision block 630, and the request is a map, as determined in decision block 634, the process confirms synchronization in block 636, prepares and sends an appropriate response to the mobile client 130 in block 606, and waits for the next request in block 602. If, however, the request is not a map, as determined in decision block 634, the process waits for the next request in block 602.

Similarly, if the source of the request is the connection tool 118, as determined in decision block 612, and the request is an upload, as determined in decision block 638, the process populates the repository with initial share space information in block 640, prepares and sends an appropriate response to the connection tool 118 in block 610, and waits for the next request in block 602. If, however, the request is not an upload, as determined in decision block 638, and the request is an add, as determined in decision block 642, the process adds new records to the repository in block 644, prepares and sends an appropriate response to the connection tool 118 in block 610, and waits for the next request in block 602. If, however, the request is not an add, as determined in decision block 642, and the request is a modify, as determined in decision block 646, the process modifies an existing record from the repository in block 648, prepares and sends an appropriate response to the connection tool 118 in block 606, and waits for the next request in block 602. If, however, the request is not a modify, as determined in decision block 646, and the request is a remove, as determined in decision block 650, the process deletes an existing record in the repository in block 652, prepares and sends an appropriate response to the connection tool 118 in block 606, and waits for the next request in block 602. If, however, the request is not a remove, as determined in decision block 650, and the request is a poll or get, as determined in decision block 654, the process gets changes from the repository block 656, prepares and sends an appropriate response to the connection tool 118 in block 606, and waits for the next request in block 602. If, however, the request is not a poll or get, as determined in decision block 654, the process waits for the next request in block 602.

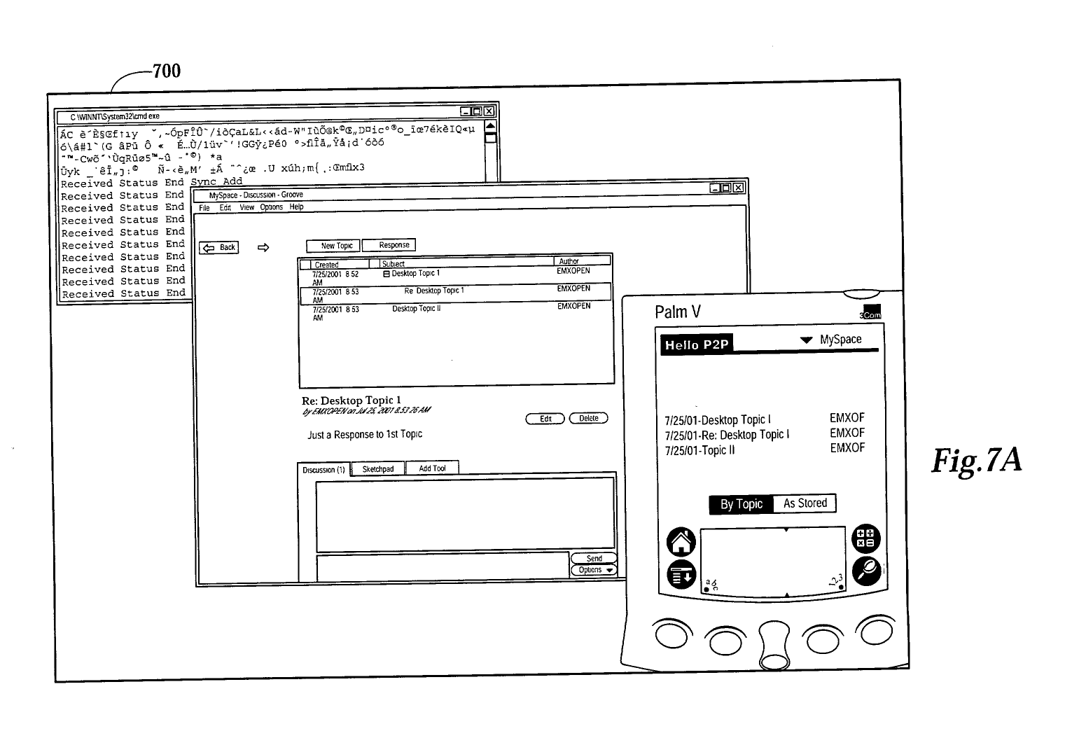

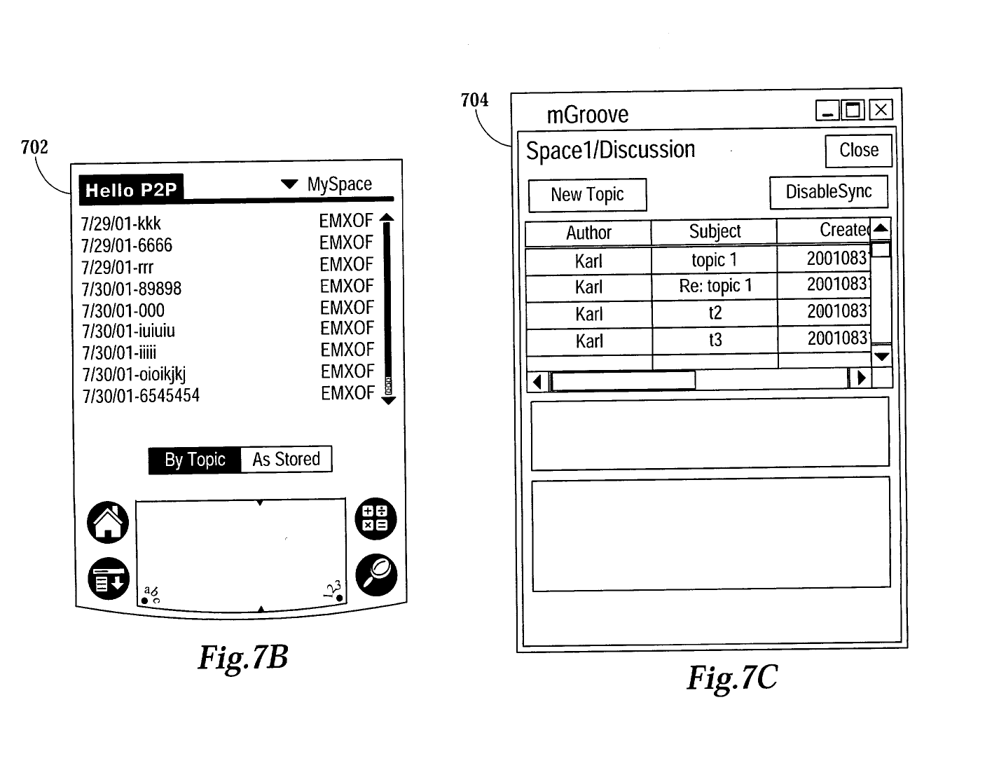

Referring now to FIGS. 7A, 7B and 7C, various screen shots 700, 702 and 704 of a mobile client 130 are shown in accordance with one embodiment of the present invention. Screen shots 700, 702 and 704 show an example of one implementation. As will be appreciated by those skilled in the art, many other implementations are possible using the present invention.

The embodiments and examples set forth herein are presented to best explain the present invention and its practical application and to thereby enable those skilled in the art to make and utilize the invention. However, those skilled in the art will recognize that the foregoing description and examples have been presented for the purpose of illustration and example only. The description as set forth is not intended to be exhaustive or to limit the invention to the precise form disclosed. Many modifications and variations are possible in light of the above teaching without departing from the spirit and scope of the following claims.

What is claimed is:

1. A method for conducting peer-to-peer communications with a terminal via a wireless network, the method comprising the steps of:
receiving a request from the terminal via the wireless network;
updating one or more records of a mobile agent repository based on the request such that the mobile agent repository mirrors a content within a shared space on the terminal; and
sending a response to the terminal via the wireless network.

2. The method as recited in claim 1, wherein the request initializes synchronization with the terminal.

3. The method as recited in claim 1, wherein the request starts a synchronization process with the terminal.

4. The method as recited in claim 1, wherein the request includes a new record to be stored in the mobile agent repository.

5. The method as recited in claim 1, wherein the request identifies an existing record in the mobile agent repository to be deleted.

6. The method as recited in claim 1, wherein the request includes a modification to an existing record stored in the mobile agent repository.

7. The method as recited in claim 1, wherein the request a confirmation of synchronization.

8. The method as recited in claim 1, wherein the request asks for any changes to the mobile agent repository.

9. The method as recited in claim 1, wherein the request and the response are communicated via a synchronization protocol.

10. The method as recited in claim 1, further comprising the steps of:
receiving a request from a connection tool;
updating one or more records of a mobile agent repository based on the request from the connection tool; and
sending a response to the connection tool.

11. The method as recited in claim 10, wherein the request includes initial shared space information.

12. The method as recited in claim 10, wherein the request includes a new record to be stored in the mobile agent repository.

13. The method as recited in claim 10, wherein the request identifies an existing record in the mobile agent repository to be deleted.

14. The method as recited in claim 10, wherein the request includes a modification to an existing record stored in the mobile agent repository.

15. The method as recited in claim 10, wherein the request asks for any changes to the mobile agent repository.

16. The method as recited in claim 10, wherein the request and the response are communicated via a SOAP interface.

17. A computer program embodied on a computer readable medium for conducting peer-to-peer communications with a terminal via a wireless network comprising:
a code segment adapted to receive a request from the terminal via the wireless network;
a code segment adapted to update one or more records of a mobile agent repository based on the request such that the mobile agent repository mirrors a content within a shared space on the terminal; and
a code segment adapted to send a response to the terminal via the wireless network;.

18. The computer program as recited in claim 17, wherein the request initializes synchronization with the terminal.

19. The computer program as recited in claim 17, wherein the request starts a synchronization process with the terminal.

20. The computer program as recited in claim 17, wherein the request includes a new record to be stored in the mobile agent repository.

21. The computer program as recited in claim 17, wherein the request identifies an existing record in the mobile agent repository to be deleted.

22. The computer program as recited in claim 17, wherein the request includes a modification to an existing record stored in the mobile agent repository.

23. The computer program as recited in claim 17, wherein the request a confirmation of synchronization.

24. The computer program as recited in claim 17, wherein the request asks for any changes to the mobile agent repository.

25. The computer program as recited in claim 17, wherein the request and the response are communicated via a synchronization protocol.

26. The computer program as recited in claim 17, further comprising:
a code segment adapted to receive a request from a connection tool;
a code segment adapted to update one or more records of a mobile agent repository based on the request from the connection tool; and
a code segment adapted to send a response to the connection tool.

27. The computer program as recited in claim 26, wherein the request includes initial shared space information.

28. The computer program as recited in claim 26, wherein the request includes a new record to be stored in the mobile agent repository.

29. The computer program as recited in claim 26, wherein the request identifies an existing record in the mobile agent repository to be deleted.

30. The computer program as recited in claim 26, wherein the request includes a modification to an existing record stored in the mobile agent repository.

31. The computer program as recited in claim 26, wherein the request asks for any changes to the mobile agent repository.

32. The computer program as recited in claim 26, wherein the request and the response are communicated via a SOAP interface.

33. An apparatus for conducting peer-to-peer communications with a terminal via a wireless network comprising:
a communications interface for communicably coupling to the terminal via the network;
a navigator communicably coupled to the communications interface;
a repository communicably coupled to the navigator, the repository having one or more records;
the navigator receiving a request from the terminal via the wireless network and the communications interface, updating one or more records of the repository based on the request such that the repository mirrors a content within a shared space on the terminal, and sending a response to the terminal via the wireless network and the communications interface.

34. The apparatus as recited in claim 33, wherein the request initializes synchronization with the terminal.

35. The apparatus as recited in claim 33, wherein the request starts a synchronization process with the terminal.

36. The apparatus as recited in claim 33, wherein the request includes a new record to be stored in the mobile agent repository.

37. The apparatus as recited in claim 33, wherein the request identifies an existing record in the mobile agent repository to be deleted.

38. The apparatus as recited in claim 33, wherein the request includes a modification to an existing record stored in the mobile agent repository.

39. The apparatus as recited in claim 33, wherein the request a confirmation of synchronization.

40. The apparatus as recited in claim 33, wherein the request asks for any changes to the mobile agent repository.

41. The apparatus as recited in claim 33, wherein the request and the response are communicated via a synchronization protocol.

42. The apparatus as recited in claim 33, wherein the navigator further receives a request from a connection tool, updates one or more records of the repository based on the request from the connection tool and sends a response to the connection tool.

43. The apparatus as recited in claim 42, wherein the request includes initial shared space information.

44. The apparatus as recited in claim 42, wherein the request includes a new record to be stored in the mobile agent repository.

45. The apparatus as recited in claim 42, wherein the request identifies an existing record in the mobile agent repository to be deleted.

46. The apparatus as recited in claim 42, wherein the request includes a modification to an existing record stored in the mobile agent repository.

47. The apparatus as recited in claim 42, wherein the request asks for any changes to the mobile agent repository.

48. The apparatus as recited in claim 42, wherein the request and the response are communicated via a SOAP interface.
